(19) United States
(12) Patent Application Publication
(10) Pub. No.: US 2025/0326035 A1
(43) Pub. Date: Oct. 23, 2025

(54) METHOD OF AND SYSTEM FOR FORMING AN ARTICLE FROM POWDER

(71) Applicant: GM GLOBAL TECHNLOLGY OPERATIONS LLC, Detroit, MI (US)

(72) Inventors: Steven L. Corzyk, Farmington Hills, MI (US); Zachary P. Steffes, West Bloomfield, MI (US); Adam McFarland, Royal Oak, MI (US); Matt A. Lakes, Sterling Heights, MI (US)

(73) Assignee: GM GLOBAL TECHNOLOGY OPERATIONS LLC, Detroit, MI (US)

(21) Appl. No.: 18/637,820

(22) Filed: Apr. 17, 2024

(51) Int. Cl. B22F 10/34; B22F 10/28; B22F 10/73; B22F 10/85; B22F 12/90; B33Y 10/00; B33Y 30/00; B33Y 40/00; B33Y 50/02

(52) U.S. Cl. CPC B22F 10/34; B22F 10/28; B22F 10/73; B22F 10/85; B22F 12/90; B33Y 10/00; B33Y 30/00; B33Y 40/00; B33Y 50/02; B22F 2203/00; B22F 2998/10

(57) ABSTRACT

A method of forming an article includes sequentially depositing a plurality of individual layers of a batch powder upon one another and fusing together the plurality of individual layers to form a workpiece and excess powder. The method includes recovering the excess powder from the workpiece to thereby form the article. Concurrent to recovering, the method includes continuously analyzing a color of the excess powder to provide a color value and distributing the excess powder according to the color value by at least one of: mixing a supply powder with at least a portion of the excess powder in a ratio of supply powder to excess powder to form a subsequent batch powder, and quarantining the excess powder from the supply powder. A system for forming an article is also described.

### INTRODUCTION

The disclosure relates to a method of and system for forming an article from powder.

Additive manufacturing refers to forming a three-dimensional object layer-by-layer. In particular, layers of material may be deposited upon one another under computer control to produce the three-dimensional object.

Powder bed fusion is a category of additive manufacturing that involves selectively fusing regions of a powder bed layer-by-layer to form the three-dimensional object. Powder bed fusion processes such as selective laser sintering, high speed sintering, direct metal laser sintering, electron beam melting, and multi jet fusion may be suitable for producing dense, durable components from metals, polymers, and ceramics that cannot be easily produced by other subtractive manufacturing methods.

For example, multi jet fusion processes may deposit a thin layer of powder and fusing agents across a computer-controlled print bed, and the fusing agents may melt such that the powder binds together. After one layer is fused, another layer of powder may be spread across the first layer so that the three-dimensional object may be built from the bottom up without the need for custom tooling or molds.

### SUMMARY

A method of forming an article includes sequentially depositing a plurality of individual layers of a batch powder upon one another and fusing together the plurality of individual layers to form a workpiece and excess powder. The method also includes recovering the excess powder from the workpiece to thereby form the article. Concurrent to recovering, the method further includes continuously analyzing a color of the excess powder to provide a color value and distributing the excess powder according to the color value by at least one of: mixing a supply powder with at least a portion of the excess powder in a ratio of supply powder to excess powder to form a subsequent batch powder, and quarantining the excess powder from the supply powder.

In one aspect, continuously analyzing may include determining whether and in what quantity to reuse the excess powder.

In another aspect, continuously analyzing may include measuring the color with a colorimeter while recovering the excess powder to determine one of: a first ratio of supply powder to excess powder corresponding to a first condition in which the color value is less than or equal to an exceptional value, a second ratio of supply powder to excess powder corresponding to a second condition in which the color value is less than or equal to a nominal value and greater than the exceptional value, a third ratio of supply powder to excess powder corresponding to a third condition in which the color value is less than or equal to a threshold value and greater than the nominal value, and a fourth condition in which the color value is greater than the threshold value. The first ratio may be less than the second ratio and the third ratio, and the second ratio may be greater than the first ratio and less than the third ratio.

In an additional aspect, the method may further include, concurrent to determining the second condition, reusing at least the portion of the excess powder by mixing the supply powder and at least the portion of the excess powder in the first ratio to form the subsequent batch powder.

In a further aspect, continuously analyzing may include automatically adjusting at least one of the first ratio, the second ratio, and the third ratio according to the color value.

In one aspect, the method may further include, concurrent to determining the fourth condition, designating the excess powder as waste powder and diverting the excess powder away from the supply powder.

In another aspect, the method may further include, concurrent to determining the third condition, reusing at least the portion of the excess powder by mixing together the supply powder and at least the portion of the excess powder in the third ratio to form the subsequent batch powder.

In an additional aspect, the method may further include, concurrent to determining the first condition, reusing at least the portion of the excess powder by mixing together the supply powder and at least the portion of the excess powder in the first ratio to form the subsequent batch powder.

In a further aspect, recovering the excess powder may include at least one of manually recovering and automatically recovering the excess powder.

In one aspect, quarantining may include at least one of manually diverting and automatically diverting the excess powder away from the supply powder.

In another aspect, a vehicle may include the article formed by the method.

In another embodiment, a method of forming an article includes sequentially depositing a plurality of individual layers of a batch powder upon one another and fusing together the plurality of individual layers to build a three-dimensional workpiece layer-by-layer and excess powder. The method also includes recovering the excess powder from the three-dimensional workpiece to thereby form the article. Further, the method includes continuously analyzing a color of the excess powder to assign a plurality of color values as the excess powder is recovered. Concurrent to continuously analyzing, the method also includes determining at least one of: a usable condition in which one of the plurality of color values is less than or equal to a threshold value and designating the excess powder as a recovered powder, and a non-usable condition in which one of the plurality of color values is greater than the threshold value and designating the excess powder as a waste powder. Concurrent to determining the usable condition, the method includes mixing a supply powder and the recovered powder in a ratio of supply powder to recovered powder. Concurrent to determining the non-usable condition, the method includes quarantining the waste powder from the supply powder.

A system for forming an article includes an additive manufacturing device configured for sequentially depositing and fusing together a plurality of individual layers each formed from a batch powder to form a workpiece and excess powder. The system also includes a powder transfer mechanism configured for transferring the excess powder away from the workpiece to form an article. In addition, the system includes a colorimeter attached to the powder transfer mechanism and configured for continuously measuring a color of the excess powder to provide a color value as the excess powder is transferred away from the workpiece. The system further includes a data processor configured for continuously analyzing the color value, and a powder mixer configured for mixing together a supply powder and the excess powder according to the color value to form a subsequent batch powder.

In one aspect, the powder transfer mechanism may be a vacuum pipe configured for manually transferring the excess powder away from the workpiece and the colorimeter may be disposed at a distal end of the vacuum pipe.

In another aspect, the powder transfer mechanism may be a screw driven transfer apparatus that defines a cavity and is configured for automatically transferring the excess powder away from the workpiece. The colorimeter may be disposed within the cavity and enclosed by the screw driven transfer apparatus.

In an additional aspect, the additive manufacturing device may include an energy source configured for additively fusing together the plurality of layers to thereby build the workpiece layer-by-layer.

In a further aspect, the colorimeter may be enclosed by the powder transfer mechanism to shield the excess powder from external light and may include a light source to illuminate the excess powder.

In one aspect, the data processor may be configured for determining at least one of: a first condition in which the color value is less than or equal to an exceptional value, a second condition in which the color value is less than or equal to a nominal value and greater than the exceptional value, a third condition in which the color value is less than or equal to a threshold value and greater than the nominal value, and a fourth condition in which the color value is greater than the threshold value.

In another aspect, the powder mixer may be configured for mixing the supply powder and the excess powder: in a first ratio of supply powder to excess powder according to the second condition, in a second ratio of supply powder to excess powder that is greater than the first ratio according to the third condition; and in a third ratio of supply powder to excess powder that is less than the first ratio according to the first condition.

In an additional aspect, the powder transfer mechanism may be further configured for diverting a waste powder away from the supply powder according to the fourth condition.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic flow diagram of a method of forming an article.

FIG. 2 is a schematic illustration of a system for forming an article for use with the method of FIG. 1.

FIG. 3 is a schematic top view of a portion of an additive manufacturing device of the system of FIG. 2.

FIG. 4 is a schematic illustration of a portion of the method of FIG. 1 in which excess powder is recovered from a workpiece to form the article.

FIG. 5 is a graphical representation of a plurality of color values each associated with a respective one of a plurality of samples of the excess powder of FIG. 4.

FIG. 6 is a schematic flow diagram of another embodiment of the method of FIG. 1.

### DETAILED DESCRIPTION

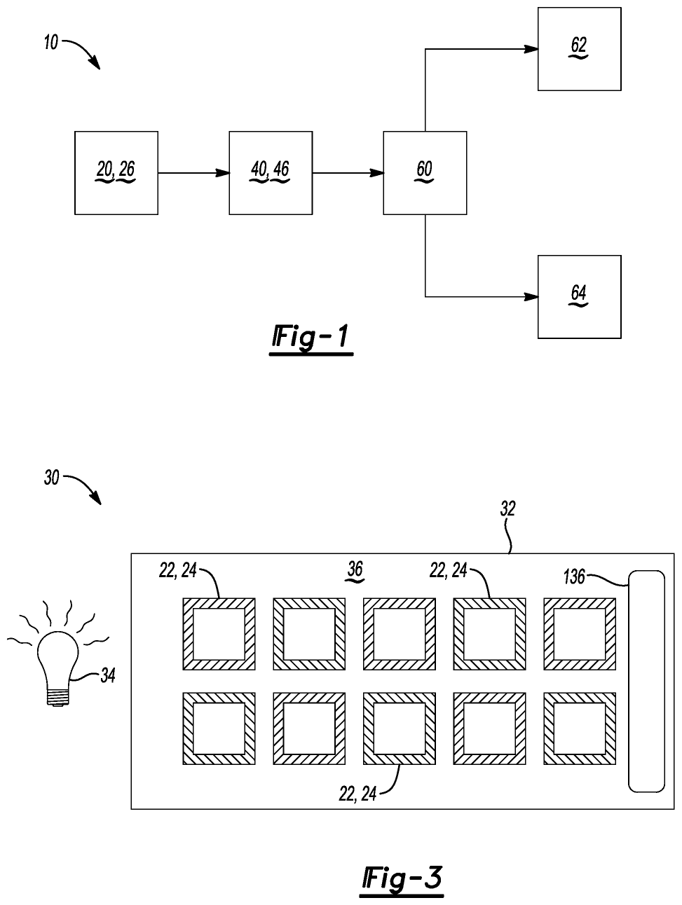

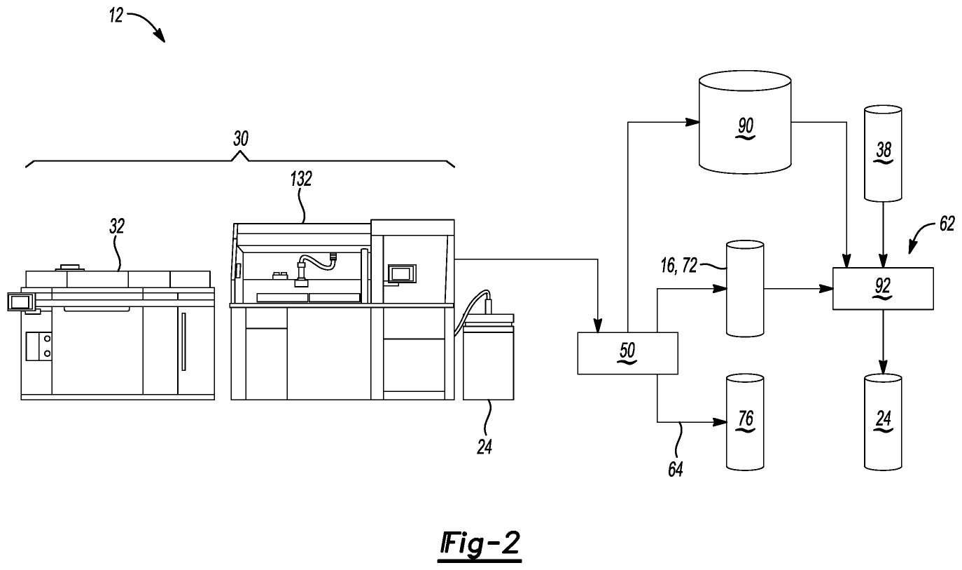

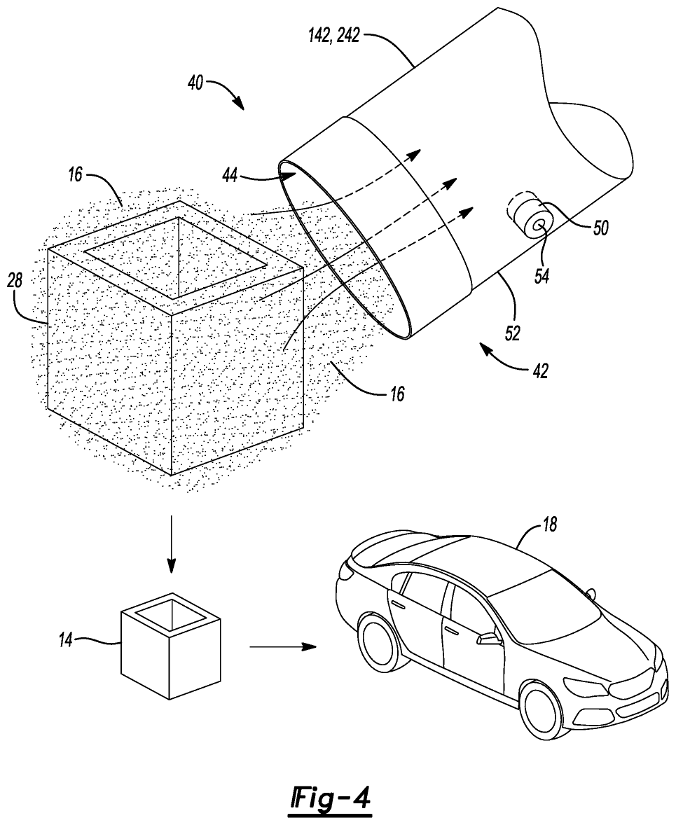

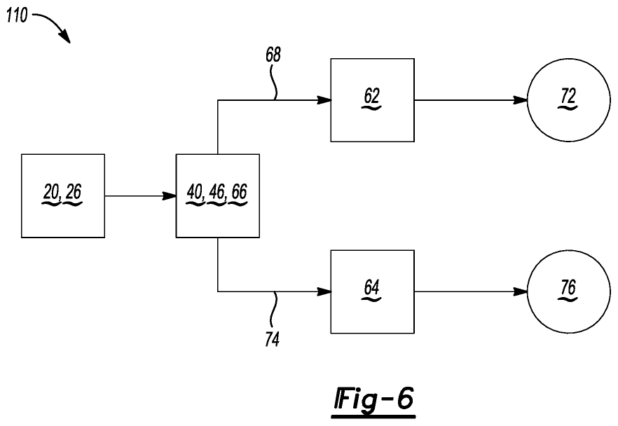

Referring to the Figures, wherein like reference numerals refer to like elements, a method 10 (FIG. 1), 110 (FIG. 6) of and system 12 (FIG. 2) for forming an article 14 (FIG. 4) is shown generally. The method 10, 110 and system 12 may be useful for applications requiring three-dimensional articles 14 additively manufactured or formed from powder. In particular, the method 10, 110 and system 12 may be useful for additively manufacturing three-dimensional articles 14 and continuously monitoring a quality of an excess powder 16 (FIG. 4) recovered during the method 10, 110. More specifically, the method 10, 110 and system 12 may be useful for continuous or in-line analysis of a color of the excess powder 16 recovered while forming the article 14. As such, the method 10, 110 and system 12 may enable an immediate and continuous determination of whether to reuse or scrap the excess powder 16 and may form articles 14 having excellent quality, mechanical properties, and isotropy.

Therefore, the method 10, 110 and system 12 may be useful for automotive applications such as, but not limited to, prototyping and manufacturing articles 14 and such as ducts, brackets, wire tracks, tools, assembly aids, and other vehicle components. That is, a vehicle 18 (FIG. 4) may include the article 14 formed by the method 10, 110. Alternatively, the method 10, 110 and system 12 may be useful for non-automotive applications such as, but not limited to, prototyping and manufacturing articles 14 and components for aerospace, aviation, transportation, construction, industrial, dental, medical, sporting goods, and consumer product applications.

Referring now to FIGS. 1-4, the method 10 includes sequentially depositing 20 (FIG. 1) a plurality of individual layers 22 (FIG. 3) of a batch powder 24 (FIGS. 2 and 3) upon one another and fusing 26 (FIG. 1) together the plurality of individual layers 22 to form a workpiece 28 (FIG. 4) and excess powder 16 (FIG. 4). Sequentially depositing 20 and fusing 26 may be referred to as an additive manufacturing process that builds the three-dimensional workpiece 28 layer-by-layer and may be accomplished by way of, as non-limiting examples, a powder bed fusion process such as selective laser sintering (SLS) and multi jet fusion (MJF).

For example, as best shown in FIGS. 2 and 3, the system 12 for forming the article 14 includes an additive manufacturing device 30, such as, but not limited to, a multi jet fusion printer 32 and processing system 132. The additive manufacturing device 30 is configured for sequentially depositing 20 and fusing 26 together the plurality of individual layers 22 (FIG. 3) each formed from the batch powder 24 to form the workpiece 28 and excess powder 16. For example, the additive manufacturing device 30 may include an energy source 34 (FIG. 3), such as one or more fusing lamps or lasers, configured for additively fusing together the plurality of layers 22 to thereby build the workpiece 28 layer-by-layer.

In one non-limiting example, a thin individual layer 22 of the batch powder 24 may be evenly distributed across a printing platform 36 (FIG. 3) or print bed, and a print carriage with multiple inkjet-style printheads may subsequently pass over the individual layer 22 to selectively deposit a fusing agent and a detailing agent. The sections of the individual layer 22 that are coated with the fusing agent may then melt with applied heat, which may cause the batch powder 24 to bind together. The detailing agent may ensure resolution and accuracy of the workpiece 28 and printed article 14. After one individual layer 22 of the eventual plurality of individual layers 22 of the workpiece 28 is fused, another individual layer 22 of the batch powder 24 may be spread across the printing platform 36 and the process may repeat until the workpiece 28 is built from a bottom up.

In greater detail as described with reference to FIG. 2, the batch powder 24 may be fed and loaded to a build unit at the processing system 132, and the build unit may then be inserted into the multi jet fusion printer 32 for printing or additive manufacturing. The multi jet fusion printer 32 may include the printer head 136 (FIG. 3) that includes a plurality of jets (not shown) each configured for depositing the thin individual layer 22 of batch powder 24 onto the printing platform 36 and then depositing the fusing agent and the detailing agent onto the thin individual layer 22 according to a computer-controlled instruction or pattern. Fusion lamps may then heat the thin layer 22 to enable fusing of the batch powder 24 in the area containing the fusing agent and form a first layer of the batch powder 24. Secondly, the region of batch powder 24 that has been sprayed with the detailing agent may mark a separation between the first layer and surrounding non-fused batch powder 24. Subsequently, the printing platform 36 supporting the newly-fused first layer may lower and a new thin layer 22 of batch powder 24, fusing agent, and detailing agent may be deposited upon the first layer. Such fusing and powder deposition may then repeat until the workpiece 28 is formed or built and surrounded by excess powder 16. That is, the workpiece 28 formed by the fused together plurality of individual layers 22 may be surrounded or encased by excess powder 16, i.e., batch powder 24 that has not fused during the build or printing process.

The choice of batch powder 24, which may be made up of fresh or supply powder 38 combined with recycled excess powder 16 that has already been through the printing process as set forth in more detail below, depends on the mechanical requirements, environment, expected stresses, and operating temperatures that the article 14 will encounter during end use. Each powder material has advantages and tradeoffs that designers and engineers may consider when selecting the batch powder 24. Suitable supply powders 38 for forming the batch powder 24 may include, but are not limited to, Nylon 11; Nylon 12; polystyrene; polypropylene; polyamide/nylon composites that may include glass beads, glass fibers, carbon fibers, and aluminum; thermoplastic polyurethane; polyether block amide; talc; and combinations thereof.

Referring again to FIGS. 1 and 4, the method 10 also includes recovering 40 the excess powder 16 from the workpiece 28 to thereby form the article 14. That is, recovering 40 may include unpacking or de-caking the workpiece 28 from surrounding excess powder 16 remaining from the build or printing process to expose the article 14. Further, recovering 40 the excess powder 16 may include at least one of manually recovering and automatically recovering the excess powder 16 to expose the formed article 14.

For example, the system 12 may include, as best shown in FIG. 4, a powder transfer mechanism 42 configured for transferring the excess powder 16 away from the workpiece 28 to form the article 14. In one non-limiting example, the powder transfer mechanism 42 may be a vacuum pipe 142 configured for manually transferring the excess powder 16 away from the workpiece 28. In another non-limiting example, the powder transfer mechanism 42 may be a screw driven transfer apparatus 242 that defines an internal cavity 44 and includes a transfer screw (not shown) disposed within the cavity 44 that is configured for automatically transferring the excess powder 16 away from the workpiece 28. In use, an operator may position the powder transfer mechanism 42 adjacent the workpiece 28 and remove and recover the excess powder 16.

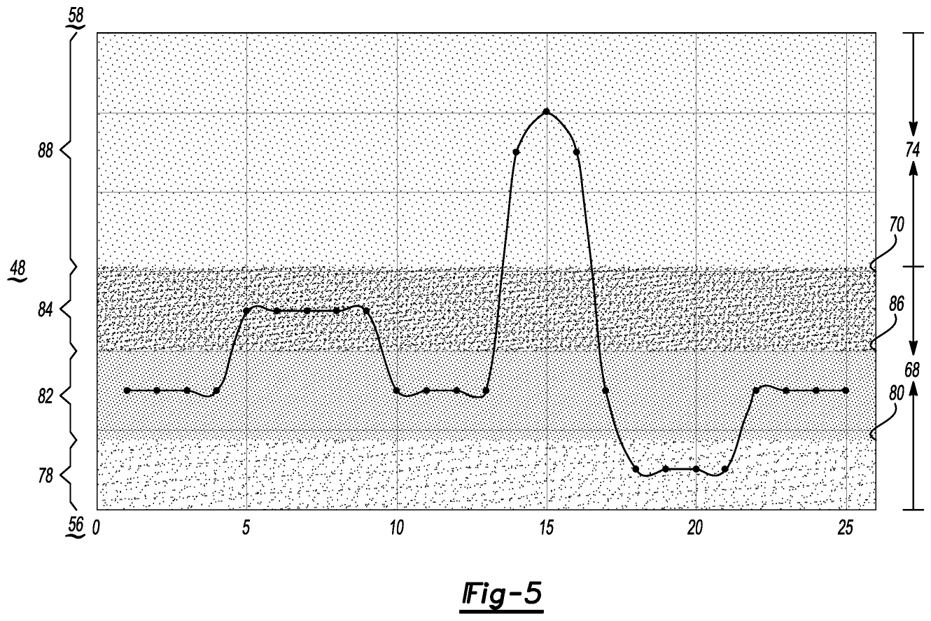

Referring again to FIG. 1, the method 10 also includes, concurrent to recovering 40, continuously analyzing 46 a color of the excess powder 16 to provide a color value 48 (FIG. 5). That is, the method 10 includes continuously analyzing 46 the color while the excess powder 16 is recovered, i.e., in an inline or online operation that may measure and analyze the color incrementally, for example, every millisecond, so that the color value 48 is continuously measured and analyzed as the excess powder 16 is removed from the workpiece 28. In one embodiment described with reference to FIG. 6, the method 10 includes repeatedly or continuously analyzing 46 the color of the excess powder 16 to assign a plurality of color values 48 (FIG. 5) as the excess powder 16 is recovered. As such, continuously analyzing 46 may include determining whether and in what quantity to reuse the excess powder 16 to form a subsequent batch powder 24, as set forth in more detail below.

For example, referring again to FIG. 4, the system 12 also includes a colorimeter 50 attached to the powder transfer mechanism 42 and configured for continuously measuring the color of the excess powder 16 to provide the color value 48 as the excess powder 16 is transferred away from the workpiece 28. The colorimeter 50 may be disposed at a distal end 52 of the powder transfer mechanism 42. That is, for embodiments in which the powder transfer mechanism 42 is a vacuum pipe 142, the colorimeter 50 may be disposed at the distal end 52 of the vacuum pipe 142 so that the colorimeter 50 measures a color of excess powder 16 as the excess powder 16 enters the vacuum pipe 142. Similarly, for embodiments in which the powder transfer mechanism 42 is the screw driven transfer apparatus 242, the colorimeter 50 may be disposed within the internal cavity 44 and enclosed by the screw driven transfer apparatus 242. That is, the colorimeter 50 may be enclosed by the powder transfer mechanism 42 to shield the excess powder 16 from external light. Accordingly, the colorimeter 50 may also include a light source 54 to illuminate the excess powder 16 as the excess powder 16 travels in front of the colorimeter 50 within the powder transfer mechanism 42 so as to ensure consistent and controlled measurement conditions.

The colorimeter 50 may be designed to measure an absorbance of a specific wavelength of light by the excess powder 16, and therefore may be capable of providing the plurality of color values 48 as the excess powder 16 is removed and recovered from the workpiece 28. In one non-limiting example, the colorimeter 50 may provide the color value 48 according to the International Commission on Illumination color space (CIELAB) in which L* refers to lightness and defines black at 0 and white at 100; a* refers to green and red opponent colors, with negative values assigned to green and positive values assigned to red; and b* refers to blue and yellow opponent colors, with negative values assigned to blue and positive values assigned to yellow.

Generally, higher L* values (i.e., a lighter color) may correlate with better flow and spreadability of powder. Higher chromaticity (i.e., higher a* and b* values) may indicate aging or chemical changes in powder over time and usage. The quantitative representation of color as the color value 48 may enable excellent powder quality control and reproducibility in the method 10, 110 and the system 12.

Referring again to FIGS. 4 and 5, as the excess powder 16 is recovered from the workpiece 28 by the powder transfer mechanism 42, the colorimeter 50 may continuously measure the color of the excess powder 16 as the excess powder 16 passes or flows in front of the colorimeter 50 within the internal cavity 44 of the powder transfer mechanism 42. That is, the colorimeter 50 may provide the plurality of color values 48 (FIG. 5) at a continuous interval, e.g., at increments without gaps or interruption, so that a quality of the excess powder 16 may be monitored. By way of a non-limiting example, the colorimeter 50 may provide the b* color value 48 of the excess powder 16, shown along a vertical axis of the graphical representation in FIG. 5, pertaining to a relative whiteness 56/yellowness 58 of the excess powder 16. In general, the fresh or supply powder 38 and resulting excess powder 16 may become more yellow 58 and less white 56 as the powder 16, 38 deteriorates due to oxidation and discolors. Similarly, excess powder 16 recovered from directly adjacent to the workpiece 28 may deteriorate faster than excess powder 16 in other areas as a result of exposure to comparatively higher heat during fusing 26. Such deterioration may contribute to formation of undesirable articles 14.

Therefore, since excess powder 16 that is more yellow 58 (FIG. 5) may be indicative of an impending performance deviation of the subsequent batch powder 24, the b* color value 48 may be associated with quality of the excess powder 16 and may determine whether and in what quantity the excess powder 16 may be recycled and reused for subsequent batch powders 24. By monitoring the color value 48 of the excess powder 16 profile during recovery from the workpiece 28, the method 10 may include correlating color changes to optimal moisture content, presence of impurities, extent of caking/agglomeration, and reusability of the excess powder 16. This may ensure high quality supply powder 38 and batch powder 24 feedstock for consistent melt behavior in the additive manufacturing device 30 and for performance of the final article 14.

Therefore, referring again to FIG. 1, the method 10 also includes distributing 60 the recycled or used or excess powder 16 according to the color value 48 by at least one of: mixing 62 the supply powder 38 with at least a portion of the excess powder 16 in a ratio of supply powder 38 to excess powder 16 to form the subsequent batch powder 24; and quarantining 64 the excess powder 16 from the supply powder 38. That is, referring to FIG. 6, in one embodiment, the method 110 includes, concurrent to continuously analyzing 46, determining 66 at least one of: a usable condition 68 (FIG. 5) in which one of the plurality of color values 48 is less than or equal to a threshold value 70 (FIG. 5) and designating the excess powder 16 as a recovered powder 72 (FIG. 2); and a non-usable condition 74 (FIG. 5) in which one of the plurality of color values 48 is greater than the threshold value 70 and designating the excess powder 16 as a waste powder 76 (FIG. 2). As set forth in more detail below, determining 66 the usable condition 68 and the non-usable condition 74 may enable a continuous and/or immediate reuse or scrap decision for the excess powder 16.

Referring again to FIG. 1, the method 10 further includes distributing 60 the excess powder 16 according to the color value 48 by at least one of: mixing 62 the supply powder 38 with at least a portion of the excess powder 16 in a ratio of supply powder 38 to excess powder 16 to form the subsequent batch powder 24; and quarantining 64 the excess powder 16 from the supply powder 38. That is, in one embodiment, the method 110 includes, concurrent to determining 66 the usable condition 68 (FIG. 5), mixing 62 the supply powder 38 and the recovered powder 72 in the ratio of supply powder 38 to recovered powder 72; and concurrent to determining 66 the non-usable condition 74 (FIG. 5), quarantining 64 the waste powder 76 from the supply powder 38.

For instance, as best described with reference to FIG. 5, continuously analyzing 46 may include measuring the color with the colorimeter 50 to produce the color value 48 while recovering the excess powder 16 to determine one of: a first ratio of supply powder 38 to excess powder 16 corresponding to a first condition 78 in which the color value 48 is less than or equal to an exceptional value 80; a second ratio of supply powder 38 to excess powder 16 corresponding to a second condition 82 in which the color value 48 is less than or equal to a nominal value 86 and greater than the exceptional value 80; a third ratio of supply powder 38 to excess powder 16 corresponding to a third condition 84 in which the color value 48 is less than or equal to the threshold value 70 and greater than the nominal value 86; and a fourth condition 88 in which the color value 48 is greater than the threshold value 70.

The second ratio may be a standard or nominal ratio and may be greater than the first ratio and less than the third ratio. The first ratio may be less than the second ratio and the third ratio. For example, each of the first ratio, the second ratio, and the third ratio may be from 50:50 (supply powder 38:excess powder 16) to 20:80 (supply powder 38:excess powder 16) or from 40:60 (supply powder 38:excess powder 16) to 30:70 (supply powder 38:excess powder 16).

Such continuous analysis of the excess powder 16 by way of the colorimeter 50 disposed inline with the powder transfer mechanism 42 may allow for some or a certain portion of the excess powder 16 to be reused. For example, perhaps due to variations in an amount of fusing agent or detailing agent applied to the plurality of individual layers 22 while forming the workpiece 28, certain areas of the workpiece 28 may be subjected to a longer fuse time or higher temperatures than others. Excess powder 16 that surrounds such areas may deteriorate relatively faster than the excess powder 16 in other areas of the workpiece 28. The method 10, 110 and system 12 allow for reuse of the excess powder 16 from certain areas surrounding the workpiece 28, while excess powder 16 from other areas of the workpiece 28 may be designated as waste powder 76 and quarantined from fresh supply powder 38 for subsequent article 14 formation.

Referring now to FIG. 2, the system 12 also includes a data processor 90 configured for continuously analyzing 46 the color value 48 and determining at least one of the first condition 78, the second condition 82, the third condition 84, and the fourth condition 88. The data processor 90 may continuously analyze and/or store the color value 48 for each sample of the excess powder 16 and provide input as to potential adjustments to the amounts of supply powder 38 and excess powder 16 for the subsequent batch powder 24. As such, continuously analyzing 46 may include automatically adjusting at least one of the first ratio, the second ratio, and the third ratio according to the color value 48.

As set forth in more detail below, the data processor 90, which may be part of a computer that controls the system 12, may provide an input signal such that the computer commands the powder transfer mechanism 42 to divert excess powder 16 that does not meet the usable condition 68 or boundary to a scrap location, or for further dilution with fresh supply powder 38 until quality specifications based on the color value 48 are met. Therefore, the plurality of color values 48 may be used to automatically adjust the ratio, i.e., the first ratio, the second ratio, or the third ratio of supply powder 38 to excess powder 16, for excess powder 16 of borderline quality to produce a subsequent batch powder 24 having acceptable quality. The data processor 90 and/or computer control may also store the plurality of color values 48 for each run or build of each article 14 for a history of a given supply powder 38 and excess powder 16 to provide troubleshooting options for future articles 14. As such, the method 10, 110 and system 12 may enable computer and/or machine learning to enable maximization of excess powder 16 reuse.

Referring again to FIG. 5, the first condition 78 may result in reducing the amount of fresh supply powder 38. That is, the method 10 may include, concurrent to determining the first condition 78, reusing at least a portion of the excess powder 16 by mixing together the supply powder 38 and the portion of the excess powder 16 in the first ratio to form the subsequent batch powder 24 for forming the next article 14 via sequentially depositing 20, fusing 26, and recovering 40 as set forth above.

The second condition 82 may result in no adjustment of the ratio of supply powder 38 to excess powder 16. That is, the method 10 may include, concurrent to determining the second condition 82, maintaining the second ratio of supply powder 38 to excess powder 16 to form the subsequent batch powder 24 that is suitable for forming the next article 14.

The third condition 84 may result in increasing the amount of fresh supply powder 38. That is, the method 10 may include, concurrent to determining the third condition 84, reusing at least the portion of the excess powder 16 by mixing together the supply powder 38 and at least the portion of the excess powder 16 in the third ratio to form the subsequent batch powder 24 that is suitable for forming the next article 14.

The fourth condition may result in designating the excess powder 16 as waste powder 76 and scrapping the excess powder 16 so that the excess powder 16 is not reused. That is, the method 10 may include, concurrent to determining the fourth condition, designating the excess powder 16 as waste powder 76 and diverting the excess powder 16 away from the supply powder 38. In particular, the powder transfer mechanism 42 may be further configured for diverting waste powder 76 away from the supply powder 38 according to the fourth condition 88. For example, the powder transfer mechanism 42 (FIG. 3) may be equipped with a diverter valve that automatically diverts the excess powder 16 away from the supply powder 38 according to the fourth condition 88. Alternatively, the powder transfer mechanism 42 may be manually positioned to divert the excess powder 16 away from the supply powder 38 according to the fourth condition 88. That is, quarantining 64 may include at least one of manually diverting and automatically diverting the excess powder 16 away from the supply powder 38.

Referring again to FIG. 2, the system 12 also includes a powder mixer 92 configured for mixing together the supply powder 38 and the excess powder 16 according to the color value 48 to form the subsequent batch powder 24. That is, the powder mixer 92 may be configured for mixing the supply powder 38 and the excess powder 16 in the first ratio, the second ratio, and the third ratio.

Advantageously, the method 10, 110 and system 12 allow for continuous, inline color measurement and quality monitoring for excess powder 16 produced during formation of the article 14, and therefore allow for automatic adjustment of a ratio of supply powder 38 to excess powder 16 for forming a subsequent batch powder 24. Such continuous analysis allows for a variable recycle or reuse rate and enables a comparatively high confidence in powder quality when compared to a single sample quality measurement or color value 48 per article 14. In addition, the method 10, 110 and system 12 allow for a comparatively high reuse of recovered excess powder 16 and provide for an excellent understanding of incoming powder quality. As such, offline sampling and color measurement of the excess powder 16 may not be necessary, and the powder transfer mechanism 42 may automatically divert out-of-specification excess powder 16 away from fresh supply powder 38 to prevent contamination of subsequent batch powders 24 with the unusable excess powder 16. That is, rather than an after-the-fact analysis of excess powder 16, the method 10, 110 and system 12 allow for continuously, inline analysis of the color of the excess powder 16 to prevent contamination of supply powder 38 and formation of unacceptable articles 14.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method of forming an article, the method comprising:
sequentially depositing a plurality of individual layers of a batch powder upon one another and fusing together the plurality of individual layers to form a workpiece and excess powder;
recovering the excess powder from the workpiece to thereby form the article;
concurrent to recovering, continuously analyzing a color of the excess powder to provide a color value; and
distributing the excess powder according to the color value by at least one of:
mixing a supply powder with at least a portion of the excess powder in a ratio of supply powder to excess powder to form a subsequent batch powder; and
quarantining the excess powder from the supply powder.

2. The method of claim 1, wherein continuously analyzing includes determining whether and in what quantity to reuse the excess powder.

3. The method of claim 1, wherein continuously analyzing includes measuring the color with a colorimeter while recovering the excess powder to determine one of:
a first ratio of supply powder to excess powder corresponding to a first condition in which the color value is less than or equal to an exceptional value;
a second ratio of supply powder to excess powder corresponding to a second condition in which the color value is less than or equal to a nominal value and greater than the exceptional value;
a third ratio of supply powder to excess powder corresponding to a third condition in which the color value is less than or equal to a threshold value and greater than the nominal value; and
a fourth condition in which the color value is greater than the threshold value;
wherein the first ratio is less than the second ratio and the third ratio; and
wherein the second ratio is greater than the first ratio and less than the third ratio.

4. The method of claim 3, further including, concurrent to determining the second condition, reusing at least the portion of the excess powder by mixing the supply powder and at least the portion of the excess powder in the first ratio to form the subsequent batch powder.

5. The method of claim 3, wherein continuously analyzing includes automatically adjusting at least one of the first ratio, the second ratio, and the third ratio according to the color value.

6. The method of claim 3, further including, concurrent to determining the fourth condition, designating the excess powder as waste powder and diverting the excess powder away from the supply powder.

7. The method of claim 3, further including, concurrent to determining the third condition, reusing at least the portion of the excess powder by mixing together the supply powder and at least the portion of the excess powder in the third ratio to form the subsequent batch powder.

8. The method of claim 3, further including, concurrent to determining the first condition, reusing at least the portion of the excess powder by mixing together the supply powder and at least the portion of the excess powder in the first ratio to form the subsequent batch powder.

9. The method of claim 1, wherein recovering the excess powder includes at least one of manually recovering and automatically recovering the excess powder.

10. The method of claim 1, wherein quarantining includes at least one of manually diverting and automatically diverting the excess powder away from the supply powder.

11. A vehicle including the article formed by the method of claim 1.

12. A method of forming an article, the method comprising:
sequentially depositing a plurality of individual layers of a batch powder upon one another and fusing together the plurality of individual layers to build a three-dimensional workpiece layer-by-layer and excess powder;
recovering the excess powder from the three-dimensional workpiece to thereby form the article;
continuously analyzing a color of the excess powder to assign a plurality of color values as the excess powder is recovered; and
concurrent to continuously analyzing, determining at least one of:
a usable condition in which one of the plurality of color values is less than or equal to a threshold value and designating the excess powder as a recovered powder; and
a non-usable condition in which one of the plurality of color values is greater than the threshold value and designating the excess powder as a waste powder;
concurrent to determining the usable condition, mixing a supply powder and the recovered powder in a ratio of supply powder to recovered powder; and
concurrent to determining the non-usable condition, quarantining the waste powder from the supply powder.

13. A system for forming an article, the system comprising:
an additive manufacturing device configured for sequentially depositing and fusing together a plurality of individual layers each formed from a batch powder to form a workpiece and excess powder;
a powder transfer mechanism configured for transferring the excess powder away from the workpiece to form an article;
a colorimeter attached to the powder transfer mechanism and configured for continuously measuring a color of the excess powder to provide a color value as the excess powder is transferred away from the workpiece;
a data processor configured for continuously analyzing the color value; and
a powder mixer configured for mixing together a supply powder and the excess powder according to the color value to form a subsequent batch powder.

14. The system of claim 13, wherein the powder transfer mechanism is a vacuum pipe configured for manually transferring the excess powder away from the workpiece and the colorimeter is disposed at a distal end of the vacuum pipe.

15. The system of claim 13, wherein the powder transfer mechanism is a screw driven transfer apparatus that defines a cavity and is configured for automatically transferring the excess powder away from the workpiece, and wherein the colorimeter is disposed within the cavity and enclosed by the screw driven transfer apparatus.

16. The system of claim 13, wherein the additive manufacturing device includes an energy source configured for additively fusing together the plurality of layers to thereby build the workpiece layer-by-layer.

17. The system of claim 13, wherein the colorimeter is enclosed by the powder transfer mechanism to shield the excess powder from external light and includes a light source to illuminate the excess powder.

18. The system of claim 13, wherein the data processor is configured for determining at least one of:
a first condition in which the color value is less than or equal to an exceptional value;
a second condition in which the color value is less than or equal to a nominal value and greater than the exceptional value;
a third condition in which the color value is less than or equal to a threshold value and greater than the nominal value; and
a fourth condition in which the color value is greater than the threshold value.

19. The system of claim 18, wherein the powder mixer is configured for mixing the supply powder and the excess powder:
in a first ratio of supply powder to excess powder according to the second condition;
in a second ratio of supply powder to excess powder that is greater than the first ratio according to the third condition; and
in a third ratio of supply powder to excess powder that is less than the first ratio according to the first condition.

20. The system of claim 18, wherein the powder transfer mechanism is further configured for diverting a waste powder away from the supply powder according to the fourth condition.
